(19) United States
(12) Patent Application Publication
(10) Pub. No.: US 2025/0201051 A1
(43) Pub. Date: Jun. 19, 2025

(54) VIRTUAL REALITY CASINO GENERATION

(71) Applicant: IGT, Las Vegas, NV (US)

(72) Inventor: Dwayne NELSON, Las Vegas, NV (US)

(73) Assignee: IGT, Las Vegas, NV (US)

(21) Appl. No.: 18/538,763

(22) Filed: Dec. 13, 2023

(51) Int. Cl. G07F 17/32

(52) U.S. Cl. CPC G07F 17/3213; G07F 17/3227; G07F 17/323; G07F 17/3237; G07F 17/3267

(57) ABSTRACT

A system includes a communication interface, a processing circuit and a memory coupled to the processing circuit. The memory includes machine readable instructions that, when executed by the processing circuit, cause the processing circuit to receive, into the processing circuit, trigger data that corresponds to a virtual reality (VR) casino component and to generate, by the processing circuit, the VR casino component that corresponds to the trigger data. The processor circuit is further caused to apply custom characteristic data that is associated with an operator of the VR casino component to generate a VR casino component model and receive operational data that is associated with performance of the VR casino component.

### BACKGROUND

Embodiments described herein relate to virtual reality systems and methods.

Physical casinos may provide multiple types of gaming devices that may be accessed by a player. Gaming devices and/or opportunities may include electronic gaming machines (EGMs), electronic table games (EGMs) and/or other wagering terminals that may be capable of attracting players based on access to wagering opportunities. Physical casinos that include these types of devices may not appeal to all players and/or types thereof. Increasing wagering opportunities and interfaces may provide increased interest in wagering.

### BRIEF SUMMARY

Embodiments herein are directed to systems that include a communication interface, a processing circuit, and a memory coupled to the processing circuit. The memory may include machine readable instructions that, when executed by the processing circuit, cause the processing circuit to receive, into the processing circuit, trigger data that corresponds to a virtual reality (VR) casino component and generate, by the processing circuit, the VR casino component that corresponds to the trigger data. The processing circuit is further caused to apply custom characteristic data that is associated with an operator of the VR casino component to generate a VR casino component model and receive operational data that is associated with performance of the VR casino component.

Some embodiments are directed to methods that include performing operations according to some embodiments. Operations according to some embodiments include receiving, into a VR casino generation server, a VR casino generation event trigger that is based on VR casino related events. Operations include generating identified areas of the VR casino based on the VR casino relate events and generating VR casino areas that are identified. Operations further include applying customizations that correspond to a customer to the VR casino areas to provide a VR casino model and publishing the VR casino model in response to a publication event. Operations include operating, by a player, the VR casino model and determining operation data corresponding to the VR casino model. Operations may include analyzing the operation data to identify under performing areas and over performing areas and regenerating the VR casino model using artificial intelligence based on the under performing areas and over performing areas.

Some embodiments are directed to a system that includes a processing circuit and a memory coupled to the processing circuit. The memory includes machine readable instructions that, when executed by the processing circuit, cause the processing circuit to receive, into the processing circuit, trigger data that corresponds to a virtual reality (VR) casino component. In some embodiments, the trigger data occurs based on a periodic time interval. The processing circuit may further generate the VR casino component that corresponds to the trigger data and apply custom characteristic data that is associated with an operator of the VR casino component that is associated with an operator to generate a VR casino component model. The processing circuit may further receive operational data that is associated with performance of the VR casino component. In some embodiments, the processing circuit is further caused to analyze operational data of the VR casino component to determine performance of an element in the VR casino component. In response to the performance of the element not being a range between a lower performance threshold and an upper performance threshold that is greater than the lower performance threshold, the processing circuit is further caused to regenerate the element in the VR casino component. In some embodiments, regenerating includes using artificial intelligence to generate a model of the VR casino component.

### BRIEF DESCRIPTION OF SEVERAL VIEWS OF THE DRAWINGS

FIG. 1 is a schematic block diagram illustrating a network configuration for a plurality of gaming devices according to some embodiments.

FIGS. 2A to 2E illustrate augmented/virtual reality viewing devices according to various embodiments.

FIG. 2F is a schematic block diagram of an augmented/virtual reality device according to some embodiments.

FIG. 3A is a perspective view of a gaming device that can be configured according to some embodiments.

FIG. 3B is a schematic block diagram illustrating an electronic configuration for a gaming device according to some embodiments.

FIG. 3C is a schematic block diagram that illustrates various functional modules of a gaming device according to some embodiments.

FIG. 3D is a perspective view of a gaming device that can be configured according to some embodiments.

FIG. 3E is a perspective view of a gaming device according to further embodiments.

FIG. 4 is a block diagram that illustrates various components of a VR controller according to some embodiments.

FIG. 5 is a schematic block diagram that illustrates operations for generating VR casinos in accordance with some embodiments.

FIG. 6 is a schematic block diagram of triggers as used in generating VR casinos according to some embodiments.

FIG. 7 is a flowchart illustrating operations of systems/methods for generating VR casinos according to some embodiments.

FIG. 8 is a flowchart illustrating operations of systems/methods for generating VR casinos according to some embodiments.

FIG. 9 is a flowchart illustrating operations of systems/methods for generating VR casinos according to some embodiments.

### DETAILED DESCRIPTION

Provided herein are methods for generating virtual reality (VR) casinos. In some embodiments, VR casinos may exist with present day physical casinos. In some embodiments, operations for generating how and/or when some or all of a VR casino is generated. Embodiments may describe a new casino model in which a casino operator may have more than one VR casino and each VR casino can be generated for one or more players. Such casino model may provide greater flexibility and responsiveness to attract new players to a VR casino. Embodiments may include events that trigger the regeneration of all or part of the VR casino.

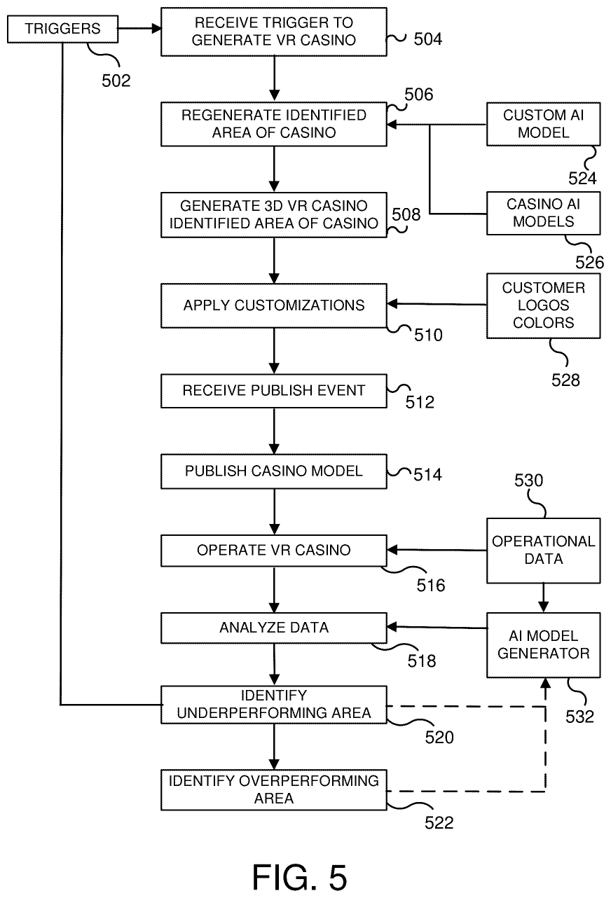

Reference is made to FIG. 5, which is a schematic block diagram that illustrates operations for generating VR casinos in accordance with some embodiments. In some embodiments, one or more triggers may be determined. Systems herein may receive (block 504) one or more triggers 502, which may cause a generation and/or a regeneration (block 506) of part or all of a VR casino.

In some embodiments, generating the VR casino may include combining the parameters from the operator, with the analysis of game play, artificial intelligence, customer parameters and/or customer assets, among others.

For example, regenerating the identified area of a casino may include receiving one or more custom artificial intelligence (AI) models (block 524) and/or receive one or more casino AI models (block 526). For example, the operator may provide the graphic theme of the casino such as colors, logos and patterns (e.g., carpet). The operator may provide a desired number of slot machines and table games. In some embodiments the operator might provide desired areas such as a bar, poker room, high roller area, and/or a tourist area, among others. Some embodiments provide that the VR casino is generated from this information. For example, the VR casino generated may have a bank of progressive themes with a denomination of $1,000 and a top prize of $10,000 since the parameters determined this was the correct EGM configuration for this area of the VR casino.

In some embodiments, customer provided customizations may be applied (block 510). Customer provided customizations (block 528) may include colors, logos, lighting, shapes and/or themes, among others.

In some embodiments, a VR casino may be generated from the 3D model of the operator's physical casino. In some embodiments, some or all of the VR casino may match the physical casino of the operator.

In some embodiments there may be a delay in publishing a VR casino to accommodate events, schedules, and/or transitions from a current VR casino and to another VR casino. Once a publish event is received (block 512) that VR casino model may be published (block 514). Once the VR casino is published, the VR casino may commence operation (block 516) based, at least partially on operational data (block 530). In some embodiments, the operational data (block 530) may be provided to an AI model generator (block 532) that may provide AI based data to be further analyzed.

Once the VR casino is operating, the system may identify (block 520) any underperforming areas of the VR casino. In the case of one or more underperforming areas, one or more triggers block 502 may be generated and/or selected. The system may further identify (522) any overperforming areas of the VR casino. In some embodiments, the AI model generator 532 may be provided with the underperforming and/or overperforming data.

Some embodiments provide that the entire casino does not need to be regenerated. For example, if the poker area of the casino is not performing well, only the poker area may be regenerated. In some embodiments, a new high roller theme may be approved so the high roller section of the casino is regenerated.

In some embodiments, generating the casino may include creating the 3D models, graphics and/or sounds of a VR casino. The generation may assign game themes and game rules to EGMs and/or ETGs, among others. The generation may assign rules to various areas of the casino such as a high roller area that requires gold club membership and a minimum player balance of $10,000.

Some embodiments provide the VR casino may be generated for one or more players, including, for example, for one or two specific players. For example, a Celebrity may join the VR casino so a new VR casino may be generated for the Celebrity and her followers. In some embodiments the newly generated casino replaces an existing casino while in other embodiments the newly generated casino is in addition to the existing casino. Responsive to players entering the VR world, a VR casino may be assigned to them based on their player status. For example, the first time a player joins the VR world he/she may be entered into the most common and basic VR casino. As the system learns the player preferences, then the player may be offered the opportunity to move to other VR casinos. For example, responsive to the system determining that the player likes poker and is a high roller, the system may enter the player into a VR casino that is customized for high rollers or poker players.

In some embodiments, the VR casino performance may be based on the play data of the VR casino. In some embodiments, the VR casino may be generated completely or partially from real world casino data. In these embodiments, the VR casino may adjust to information learned from a physical casino and/or online casino game play.

Embodiments herein may rely on the triggers that cause the generation of the VR casino. Some embodiments provide that unique VR casinos can be generate per player as they enter the casino. Some embodiments provide that VR casino play and physical VR casino play may provide data to generate the VR casino.

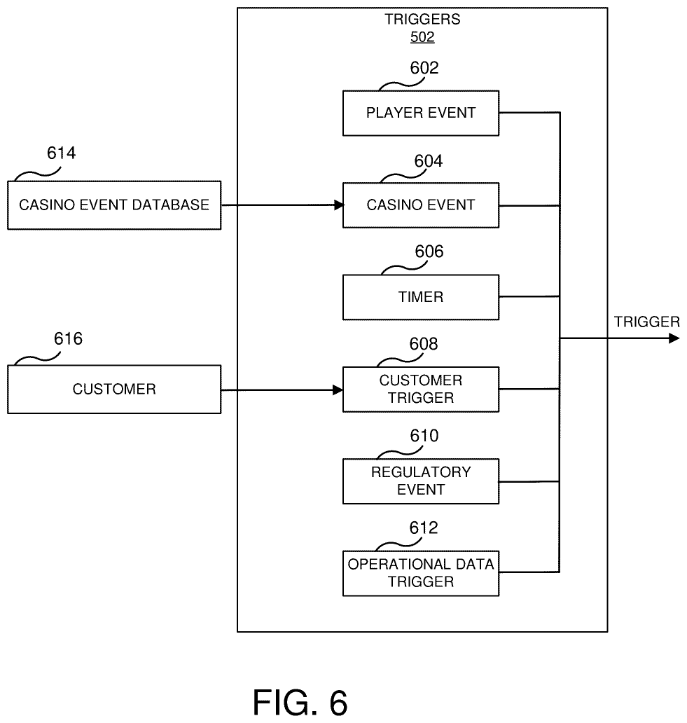

Reference is now made to FIG. 6, which is a schematic block diagram of triggers as used in generating VR casinos according to some embodiments. In some embodiments, a trigger 502 may include a player event 602, a casino event 604, a timer 606, a customer trigger 608, a regulatory event 610, and/or an operational data trigger 612 among others.

For example, a player event trigger 602 may be provided responsive to a player entering the VR casino and/or a player crossing a given threshold such as an amount of play, among others. In some embodiments, the player event trigger 602 may be provided responsive to the player having won or lost a certain amount of money and/or game plays and/or if the player has hit a certain payout level.

In some embodiments, a casino event trigger 604 may be provided based on information from a casino event database 614 and may include a given time of day, a given promotion starting and/or ending, a lucky coin event and/or the detection of underperformance of part or all of the VR casino, among others.

In some embodiments, a timer 606 may be provided to cause the VR casino to be regenerated periodically based on the latest play data. Some embodiments provide that a customer 616 may create a customer trigger 608 based on customer operational and/or regulatory events.

In some embodiments, a regulatory event trigger 610 may be provided based on the approval status of a game in the VR casino. For example, the approval status may indicate that the game is approved in a given jurisdiction. In contrast, the approval status may indicate that approval for a game is revoked in a given jurisdiction.

In some embodiments, an operation data trigger 612 may provide that the game play data of the VR casino is analyzed and compare to one or more thresholds. If the one or more thresholds is met (or not met), part or all of the VR casino may be regenerated. In some embodiments, one or more thresholds may be generated using artificial intelligence of VR casino data.

In some embodiments, a player may win a very large jackpot and a new VR casino may be generated on the fly for the player that represents the player's new high roller status. Some embodiments provide that the system may generate the casino in the background and prompt the player when the new VR casino is ready. In some embodiments, the player may be allowed to join the new VR casino on their next visit. The VR system may prompt the player by sending messages inviting the player to join. For example, a message may be “Your new casino is ready. Join Now?”.

In some embodiments, the system may generate a new VR casino for all players when a casino event happens such as an event starting on a given day. In such embodiments, a new VR casino may be generated for the event on the given day. In some embodiments, the system may generate a new casino based on the time of year. For example, a Valentine's Day themed VR casino may be generated during February.

In some embodiments, a player is eligible to join multiple VR casinos. In such embodiments, the system may prompt the player when they enter the VR world. For example, a player may be a higher roller and therefore eligible for the high roller area. Some embodiments provide that there may also be a Christmas themed VR casino. The system may prompt the player to offer to join the high roller VR casino and/or the Christmas VR casino.

In some embodiments, AI may be used to determine when to regenerate a VR casino. Some embodiments provide that an AI engine analyzes game play data and determines the appropriate time to generate a new VR casino.

In some embodiments, generation of a VR casino (part or all) may be triggered and the new VR casino is generated. Since players may be in the casino when this event happens, players who are in the VR casino and/or are in the area that was regenerated, may remain in an old version of the VR casino. In such embodiments, new players joining the VR casino may enter the new version of the VR casino. In some embodiments, the version of the VR casino (or area) may remain until there are no players using them. In some embodiments, once the old version of the VR casino is no longer being played, the old version may be deleted from the VR casino database.

Some embodiments may provide VR experiences in the casino. For example, VR may provide full immersion for the player and thus may isolate the player from its surrounding.

Some embodiments may provide that hand gestures may be detected to provide an input that may toggle between VR on and VR off modes.

In some embodiments, a casino-wide system may provide that a VR device is connected within the casino and/or with different gaming devices in the casino. In some embodiments, a VR device may be connected with other player's devices such as other headsets and/or other types of mobile terminals.

Some embodiments are directed to a wider-ranging system, such as a wide area network, any venue that is connected online, online casinos, and/or different gaming channels and/or types thereof. Examples of gaming channels may include online casino, VR casino, lottery, and/or sports betting among others. In some embodiments, a VR device may include players from around the world.

According to some embodiments, a VR device may include a manual switch for toggling between on and off modes. In such embodiments, a manual switching may include actuating a mechanical and/or electromechanical switch, providing a gesture that may be detected, and/or receiving a voice command. In this manner, the VR casino experience can be toggled based on individual preferences.

In some embodiments, VR device modes may be toggled based on automated switching. For example, some embodiments provide that each event in a casino is associated with a mode, predefined by the system. Whenever entering such an event, the corresponding mode may be activated automatically.

In some embodiments, geo-fencing for VR may be provided so that if a user goes into an area flagged by the venue, the area may cause the mode to be disabled and/or off to disable the VR device in the flagged area. Examples of flagged areas may include private areas such as washrooms or cash distribution, among others. User safety may be improved by turning the VR modes off if the user is in danger of being hurt due to inattention.

In some embodiments, a headset may include object detection included therein. Embodiments provide that object detection may turn off the XR/VR modes to prevent the user from colliding with objects and/or other users.

In some embodiments, the headset may include a microphone that may identify a name of a user and/or other key words that may be spoken. In response to detecting such sounds, the XR/VR modes made by turned off to allow a substantially transparent display to be enabled and/or may pause a game or other activity.

Some embodiments provide a customizable switch between different modes. For example, a player may save their preferences when modes are changed. In some embodiments, there may be a list of different options/experiences in which the player can select the desired mode for each one uniquely. Some embodiments provide that when entering a specific experience, the headset may toggle automatically. In some embodiments, players may customize their modes using the headset and/or an external application that may be used to pre-configure and/or use at a terminal, such as a casino terminal. In some embodiments, a player's preferences may be saved in a central database. In this manner, the same preferences may be used on different EGMs and/or types thereof. For example, regardless of the EGM and/or type thereof, the preferred settings may be automatically restored. Some embodiments, customized modes may be saved so that, when the player uses another device, the preferred settings may be automatically restored.

In some embodiments, the headset may shut down based on responsible gaming features. In some embodiments, the responsible gaming features may cause a message, such as a pop-up message, to signal excessive play, timers and/or requests for user to take breaks. Some embodiments provide that users may self-exclude to disallow devices from working while on a self-exclude list. In some embodiments, VR features may be turned off when hitting gaming limits and may log out the user. Users may be allowed to exclude certain features and/or areas such as a high roller room to support responsible gaming features. Some embodiments provide that different modes may correspond to different volatility.

In some embodiments, the headset described herein may be a casino-owned device in which the casino includes a casino pick-up station where the player receives their device from. Some embodiments provide that receiving the headset comprise a do-it-yourself station and/or a station that includes a casino staff member. In some embodiments provide that once the player receives a device, they may “pair” it to their user profile, which may be performed by scanning a player tracking card, among others. Such pairing may be with the headset itself and/or during the hand-over process.

Some embodiments may include an integrated tracking card reader. For example, the headset may have a tracking card reader integrated, so the user may not need an EGM's card reader. In some embodiments, preferred modes settings may be applied by just activating the tracking card with the headset by inserting the card, and/or by scanning it wirelessly such as via near field communication.

Some embodiments provide that a pairing mode may use the headset's camera to scan a QR code on the gaming machine's display to pair. In some embodiments, the tracking card may be entered into the machine to automatically pair the headset with the corresponding machine. In some examples, after a gaming session, the connection between headset and the gaming device may be terminated immediately through a cash out.

Some embodiments provide that the user may bring their own headset. In such cases, pairing with the casino system and/or network may be required. For example, a casino QR code may be scanned and/or a personalized access code may be received at a casino entrance. Scanning may immediately pair the device with the casino network and all its gaming features.

In some embodiments, artificial intelligence (AI) powered headsets, when in a VR mode in a casino, may partially turn off based on where a player is looking. In this manner, the player may see promotions on the screen, jackpots, and/or servers asking to take orders, among others.

In some embodiments, the VR casino may be provided as a paid feature. For example, players may not gain access to a VR casino feature, without playing and winning a certain amount at the EGM. As soon as the player wins a given amount, then the world may mutate to a VR casino version and provide a unique experience, which may tempt the player to play more.

### Virtual Reality Systems and Viewers

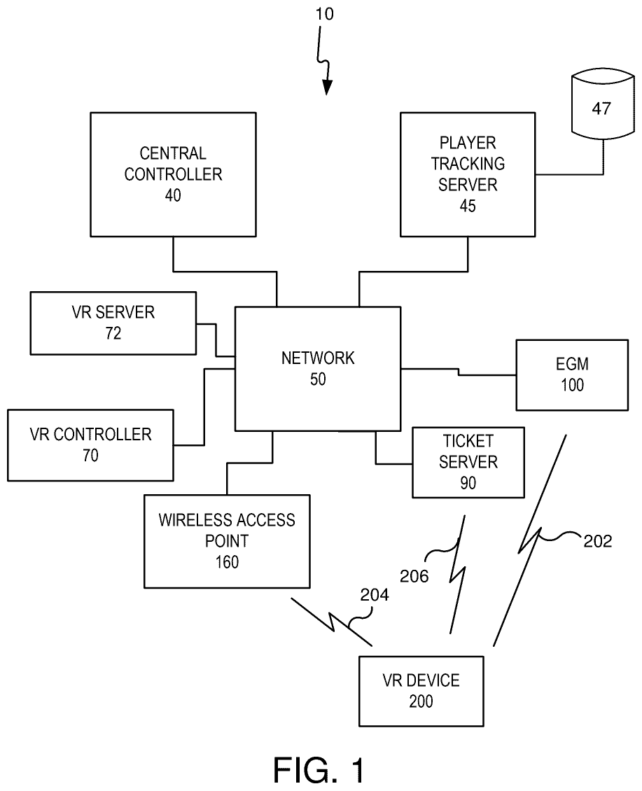

Referring to FIG. 1, a gaming system 10 including a plurality of EGMs 100 is illustrated. As discussed above, the EGMs 100 may be one type of a variety of different types of gaming devices. The gaming system 10 may be located, for example, on the premises of a gaming establishment, such as a casino. The EGMs 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the EGMs 100. Communications over the data communication network 50 may be encrypted for security. The central controller 40 may be any suitable server or computing device which includes at least one processing circuit and at least one memory or storage device. Each EGM 100 may include a processing circuit that transmits and receives events, messages, commands or any other suitable data or signal between the EGM 100 and the central controller 40. The EGM processing circuit is operable to execute such communicated events, messages or commands in conjunction with the operation of the EGM 100. Moreover, the processing circuit of the central controller 40 is configured to transmit and receive events, messages, commands or any other suitable data or signal between the central controller 40 and each of the individual EGMs 100. In some embodiments, one or more of the functions of the central controller 40 may be performed by one or more EGM processing circuits. Moreover, in some embodiments, one or more of the functions of one or more EGM processing circuits as disclosed herein may be performed by the central controller 40.

A wireless access point 160 provides wireless access to the data communication network 50. The wireless access point 160 may be connected to the data communication network 50 as illustrated in FIG. 1 or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data network 50. Each ticket server 90 may include a processing circuit that transmits and receives events, messages, commands or any other suitable data or signal between the ticket server 90 and the central controller 40. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

As further illustrated in FIG. 1, a VR device 200 is provided. The VR device 200 may communicate with one or more elements of the gaming system 10 to render two-dimensional (2D) and/or three-dimensional (3D) content to a player of one of the EGMs 100, the VR server 72, and/or the ticket server 90 in a virtual space. The VR device 200 may provide full visual content without including images of real-world objects and/or environments.

The VR device 200 may communicate with one or more elements of system 10 to coordinate the rendering of images. For example, in some embodiments, the VR device 200 may communicate directly with the ticket server 90 over a wireless interface 204, which may be a WiFi link, a Bluetooth link, an NFC link, etc. In other embodiments, the VR device 200 may communicate with the data communication network 50 (and devices connected thereto, including EGMs and the coin pusher) over a wireless interface 204 with the wireless access point 160. The wireless interface 204 may include a WiFi link, a Bluetooth link, an NFC link, etc. In further embodiments, the VR device 200 may communicate simultaneously with other network devices over the wireless interface 206 and the wireless access point 160 over the wireless interface 204. Some embodiments provide that VR device 200 may communicate with one or more of the EGMs 100 over a wireless interface 202. In these embodiments, wireless interface 202, wireless interface 204 and wireless interface 206 may use different communication protocols and/or different communication resources, such as different frequencies, time slots, spreading codes, etc. For example, in some embodiments, the wireless interface 202 may be a Bluetooth link, while the wireless interface 204 and/or 206 may be a WiFi link.

The wireless interfaces 202, 204, 206 allow the VR device 200 to coordinate the generation and rendering of images to the player via the VR device 200.

In some embodiments, the gaming system 10 includes a mixed reality controller, or VR controller 70. The VR controller 70 may be a computing system that communicates through the data communication network 50 and the VR device 200 to coordinate the generation and rendering of virtual images to one or more players using the VR devices 200. The VR controller 70 may be implemented within or separately from the central controller 40. In some embodiments, a VR server 72 may include data corresponding to a VR mode for use by a VR device 200. For example, the VR server 72 may include data corresponding to when the VR device 200 may toggle to a different mode or other VR casino and/or what events trigger the VR device 200 to change modes.

In some embodiments, the VR controller 70 may coordinate the generation and display of the virtual images of the same virtual object to more than one player by more than one VR device 200. As described in more detail below, this may enable multiple players to interact with the same virtual object and/or VR casino together in real time. This feature can be used to provide a shared multiplayer experience to multiple players at the same time.

Moreover, in some embodiments, the VR controller 70 may coordinate the generation and display of the same virtual object and/or VR casino to players at different physical locations, as will be described in more detail below.

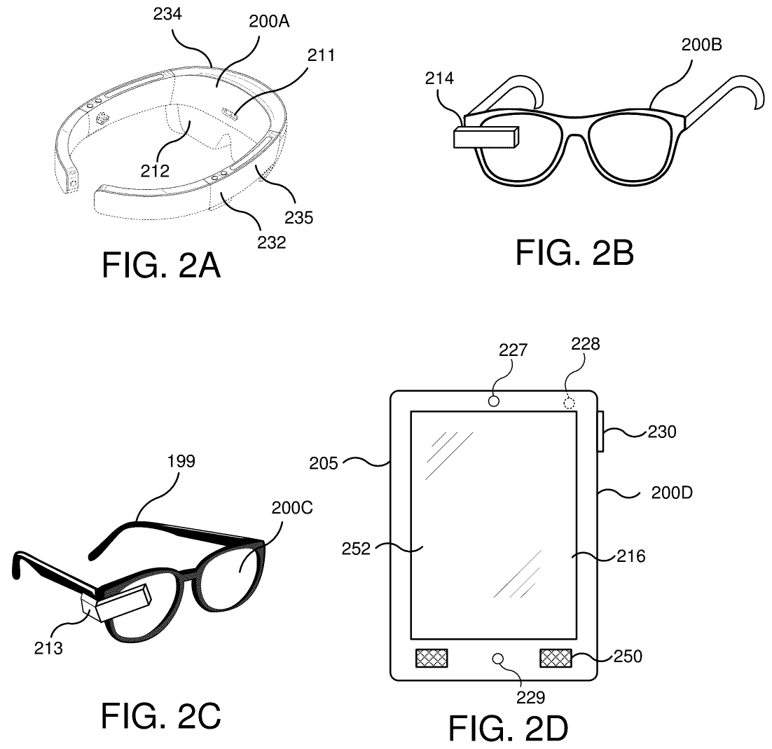

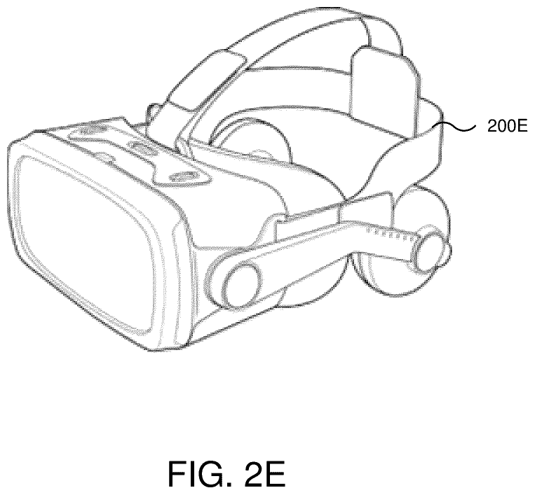

Referring to FIGS. 2A to 2E, the VR device 200 may be implemented in a number of different ways. For example, referring to FIG. 2A, in some embodiments, a VR device 200A may be implemented as a 3D headset including a pair of semitransparent lenses 212 on which images of virtual objects may be displayed. In some embodiments, the VR device 200A may be a head-mounted VR headset that includes internal screens and may mix images.

Different stereoscopic images may be displayed on the lenses 212 to create an appearance of depth, while the semitransparent nature of the lenses 212 allows the user to see both the real world as well as the 3D image rendered on the lenses 212. The VR device 200A may be implemented, for example, using a Hololens™ from Microsoft Corporation. The Microsoft Hololens includes a plurality of cameras 234 and other sensors 211 that the device uses to build a 3D model of the space around the user. The device 200A can generate a 3D image to display to the user that takes into account the real-world objects around the user and allows the user to interact with the 3D object.

The device 200A may further include other sensors 232, such as a gyroscopic sensor, a GPS sensor, one or more accelerometers, and/or other sensors that allow the device 200A to determine its position and orientation in space. In further embodiments, the device 200A may include one or more cameras that allow the device 200A to determine its position and/or orientation in space using visual simultaneous localization and mapping (VSLAM). The device 200A may further include one or more microphones and/or speakers 235 that allow the user to interact audially with the device.

Referring to FIG. 2B, a VR device 200B may be implemented as a pair of glasses 200B including a transparent prismatic display 214 that displays an image to a single eye of the user. An example of such a device is the Google Glass device. Such a device may be capable of displaying images to the user while allowing the user to see the world around the user, and as such can be used as a mixed reality viewer.

In other embodiments, referring to FIG. 2C, the VR device may be implemented using a virtual retinal display device 200C. In contrast to devices that display an image within the field of view of the user, a virtual retinal display 200C may raster scan an image directly onto the retina of the user. In some embodiments, the virtual retinal display 200C may include glasses 199 that may support and/or position virtual retinal display 200C relative to the user's eyes. In some embodiments, the virtual retinal display 200C may be configured to be removably coupled to glasses that are not provided with the virtual retinal display 200C. In such embodiments, the virtual retinal display may be used in conjunction with user supplied glasses 199 that may include lenses for correcting vision impairments. Like the device 200B, the virtual retinal display device 200C combines the displayed image with surrounding light to allow the user to see both the real world and the displayed image. However, also like the device 200B, the virtual retinal display device 200C may be incapable of displaying 3D images to the user.

In still further embodiments, a VR device 200D, as shown in FIG. 2D, may be implemented using a mobile wireless device, such as a mobile telephone, a tablet computing device, a personal digital assistant, or the like. The device 200D may be a handheld device including a housing 205 on which a touchscreen display device 216 including a digitizer 252 is provided. An input button 230 may be provided on the housing and may act as a power or control button. A rear facing camera 227 may be provided in a front face of the housing 205. The device 200D may further include a front facing camera 228 on a rear face of the housing 205. The device 200D may include one or more speakers 250 and a microphone 229. The device 200D may provide a mixed reality display by capturing a video signal using the front facing camera 228 and displaying the video signal on the display device 216, and also displaying a rendered image of a virtual object over the captured video signal. In this manner, the user may see both a mixed image of both a real object in front of the device 200D as well as a virtual object superimposed over the real object to provide a mixed reality viewing experience.

In still further embodiments, a VR device 200E, as shown in FIG. 2E, may be implemented using head mounted display that includes various features described herein including input devices like cameras and microphones as well as hand-held components (not shown here that may be used to provide inputs to the VR device. The device 200E may be a handheld device including a housing on which a touchscreen display device including a digitizer is provided. An input button may be provided on the housing and may act as a power or control button. A rear facing camera may be provided in a front face of the housing. The device 200E may further include a front facing camera on a rear face of the housing. The device 200E may include one or more speakers and a microphone. The device 200E may provide a virtual reality display based on the event server and the sports wagering system and the video signals that are generated on the device 200E.

FIG. 2F is a block diagram that illustrates various components of a VR device 200 according to some embodiments. As shown in FIG. 2F, the VR device 200 may include a processing circuit that controls operations of the VR device 200. Although illustrated as a single processing circuit, multiple special purpose and/or general-purpose processors and/or processor cores may be provided in the VR device 200. For example, the VR device 200 may include one or more of a video processor, a signal processor, a sound processor and/or a communication controller that performs one or more control functions within the VR device 200. The processing circuit 210 may be variously referred to as a “controller,” “microcontroller,” “microprocessor” or simply a “computer.” The processing circuit 210 may further include one or more application-specific integrated circuits (ASICs).

Various components of the VR device 200 are illustrated in FIG. 2F as being connected to the processing circuit 210. It will be appreciated that the components may be connected to the processing circuit 210 through a system bus, a communication bus and controller, such as a USB controller and USB bus, a network interface, or any other suitable type of connection.

The VR device 200 further includes a camera 230 for generating a video signal and a display 240 for displaying VR graphics to a user as virtual images and/or virtual elements. The VR graphics may be displayed directly within a field of view so as to appear to be present within a scene and/or may be digitally added to a live video signal so as to appear to be present within the live video signal.

The VR device 200 may include a toggle mode input 236 that is operable to receive an input signal to change the mode from among VR and off. In some embodiments, the toggle mode input 236 comprises a switch, manual or electronic, that when actuated, caused the mode to toggle. In some embodiments, the toggle mode input 236 is generated automatically to cause the mode to toggle to a different mode in response to an external event and/or trigger.

The VR device 200 further includes a memory device 212 that stores one or more functional modules 214 for performing the operations described herein.

The memory device 212 may store program code and instructions, executable by the processing circuit 210, to control the VR device 200. The memory device 210 may include random access memory (RAM), which can include volatile and/or non-volatile RAM (NVRAM) and other forms as commonly understood in the gaming industry. In some embodiments, the memory device 212 may include read only memory (ROM). In some embodiments, the memory device 212 may include flash memory and/or EEPROM (electrically erasable programmable read only memory). Any other suitable magnetic, optical and/or semiconductor memory may operate in conjunction with the gaming device disclosed herein.

The VR device 200 may include a wireless interface 220 that enables the VR device 200 to communicate with remote devices, such as EGMs 100 and/or a VR controller 70 over a wired and/or wireless communication network, such as a local area network (LAN), wide area network (WAN), cellular communication network, wireless LAN (Wifi), Bluetooth, near-field communications (NFC) or other data communication network. The wireless interface 220 may include multiple radios to support multiple types of simultaneous connections. For example, the wireless interface may include both a Wifi radio transceiver and a Bluetooth radio transceiver.

### Electronic Gaming Machines

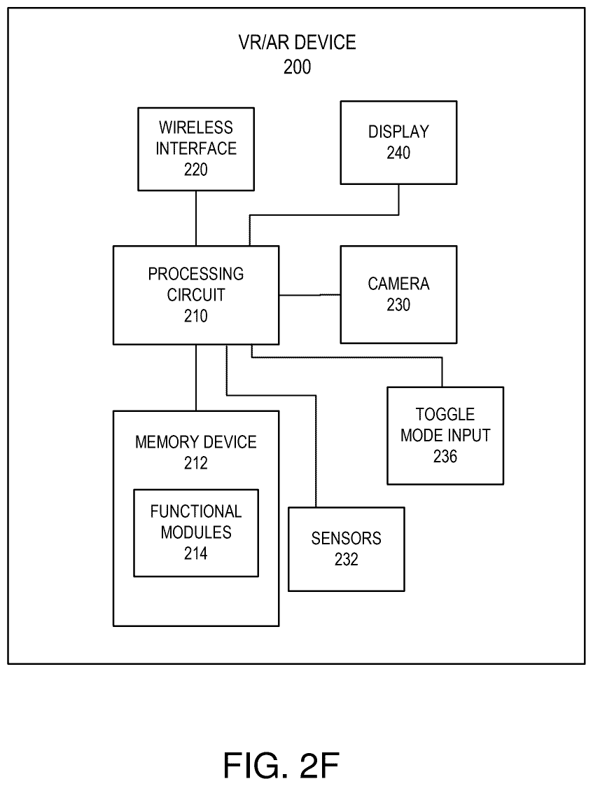

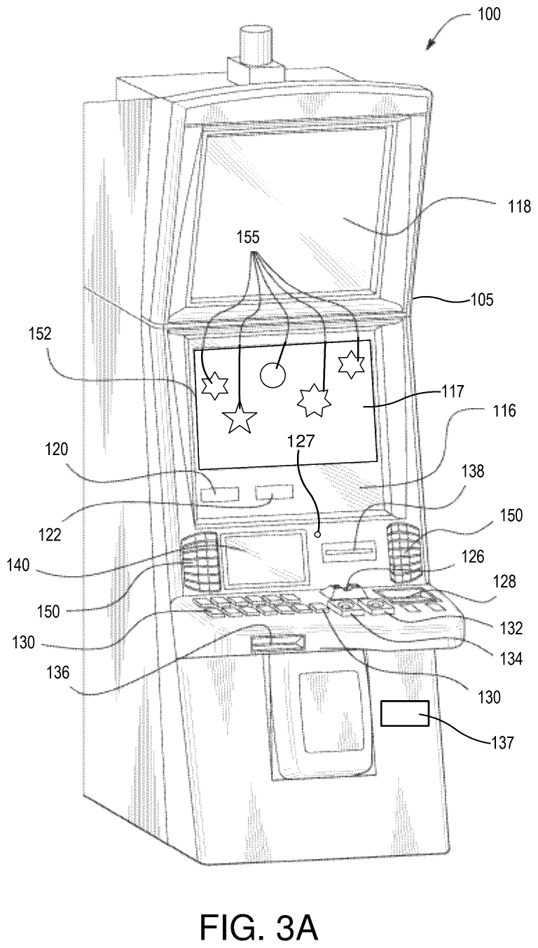

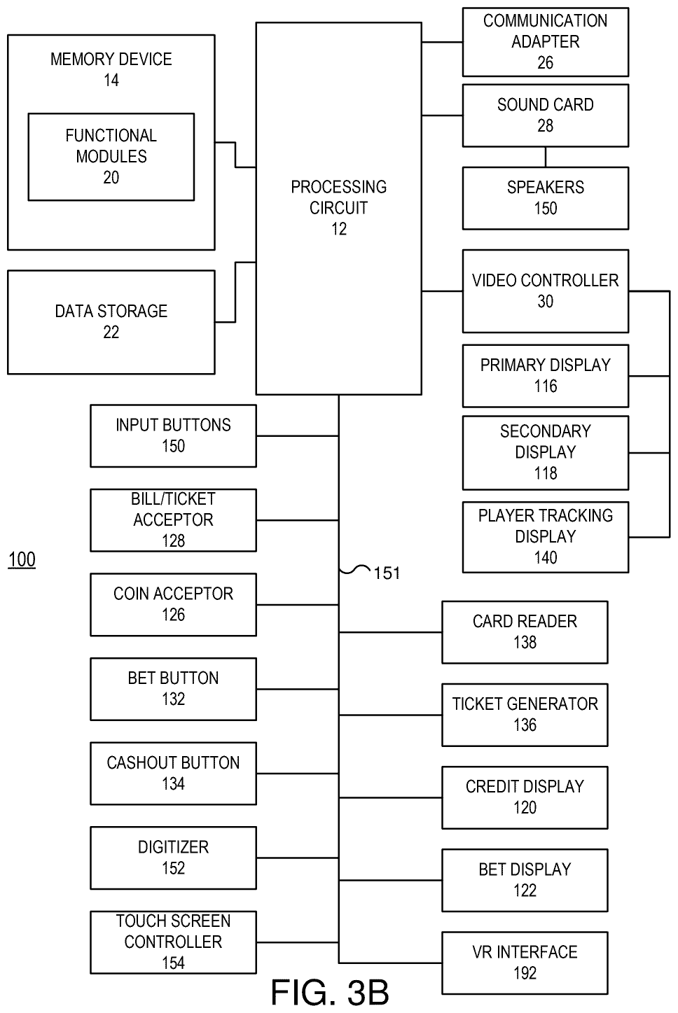

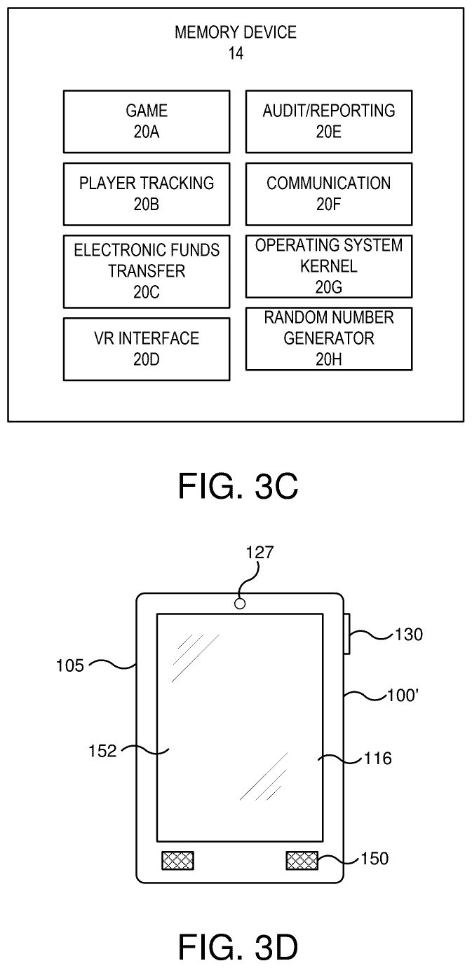

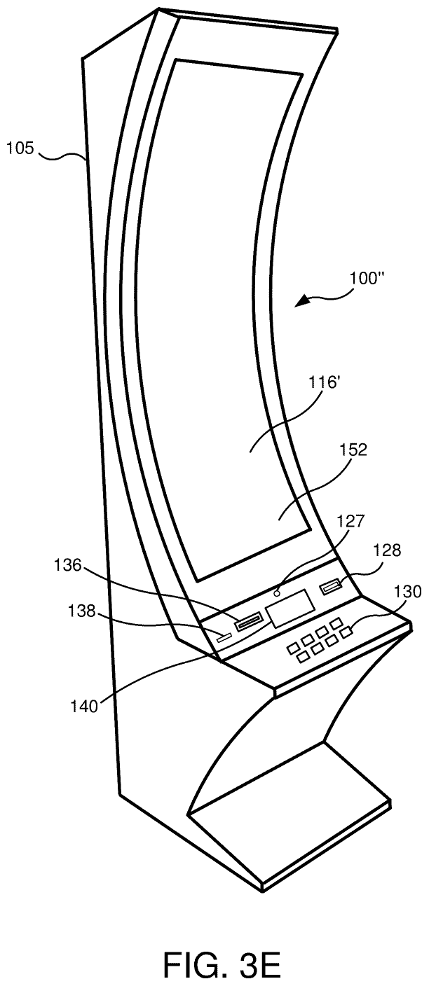

Embodiments herein may include different types of gaming devices. One example of a gaming device includes an electronic gaming machine (EGM) 100 that can interact with mixed reality viewers according to various embodiments is illustrated in FIGS. 3A, 3B, and 3C in which FIG. 3A is a perspective view of an EGM 100 illustrating various physical features of the device, FIG. 3B is a functional block diagram that schematically illustrates an electronic relationship of various elements of the EGM 100, and FIG. 3C illustrates various functional modules that can be stored in a memory device of the EGM 100. The embodiments shown in FIGS. 3A to 3C are provided as examples for illustrative purposes only. It will be appreciated that EGMs may come in many different shapes, sizes, layouts, form factors, and configurations, and with varying numbers and types of input and output devices, and that embodiments of the inventive concepts are not limited to the particular EGM structures described herein.

EGMs 100 typically include a number of standard features, many of which are illustrated in FIGS. 3A and 3B. For example, referring to FIG. 3A, an EGM 100 may include a support structure, housing or cabinet 105 which provides support for a plurality of displays, inputs, outputs, controls and other features that enable a player to interact with the EGM 100.

The EGM 100 illustrated in FIG. 3A includes a number of display devices, including a primary display device 116 located in a central portion of the cabinet 105 and a secondary display device 118 located in an upper portion of the cabinet 105. A plurality of game components 155 are displayed on a display screen 117 of the primary display device 116. It will be appreciated that one or more of the display devices 116, 118 may be omitted, or that the display devices 116, 118 may be combined into a single display device. The EGM 100 may further include a player tracking display 140, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the EGM 100.

The player tracking display 140 may be used to display a service window that allows the player to interact with, for example, their player loyalty account to obtain features, bonuses, comps, etc. In other embodiments, additional display screens may be provided beyond those illustrated in FIG. 3A. In some embodiments, one or more of the player tracking display 140, the credit display 120 and the bet display 122 may be displayed in one or more portions of one or more other displays that display other game related visual content. For example, one or more of the player tracking display 140, the credit display 120 and the bet display 122 may be displayed in a picture in a picture on one or more displays.

The EGM 100 may further include a number of input devices 130 that allow a player to provide various inputs to the EGM 100, either before, during or after a game has been played. For example, the EGM 100 may include input devices 130 that are a plurality of input buttons 130 that allow the player to select options before, during or after game play. The EGM may further include a game play initiation button 132 and a cashout button 134. The cashout button 134 is utilized to receive a cash payment or any other suitable form of payment corresponding to a quantity of remaining credits of a credit display.

In some embodiments, one or more input devices of the EGM 100 are one or more game play activation devices that are each used to initiate a play of a game on the EGM 100 or a sequence of events associated with the EGM 100 following appropriate funding of the EGM 100. The example EGM 100 illustrated in FIGS. 3A and 3B includes a game play activation device in the form of a game play initiation button 132. It should be appreciated that, in other embodiments, the EGM 100 begins game play automatically upon appropriate funding rather than upon utilization of the game play activation device.

In some embodiments, one or more input devices 130 of the EGM 100 are one or more wagering or betting devices. One such wagering or betting device includes a maximum wagering or betting device that, when utilized, causes a maximum wager to be placed. Another such wagering or betting device is a repeat the bet device that, when utilized, causes the previously-placed wager to be placed. A further such wagering or betting device is a bet one device. A bet is placed upon utilization of the bet one device. The bet is increased by one credit each time the bet one device is utilized. Upon the utilization of the bet one device, a quantity of credits shown in a credit display (as described below) decreases by one, and a number of credits shown in a bet display (as described below) increases by one.

In some embodiments, one or more of the display screens may a touch-sensitive display that includes a digitizer 152 and a touchscreen controller 154 (FIG. 3B). The player may interact with the EGM 100 by touching virtual buttons on one or more of the display devices 116, 118, 140. Accordingly, any of the above-described input devices, such as the input buttons 130, the game play initiation button 132 and/or the cashout button 134 may be provided as virtual buttons on one or more of the display devices 116, 118, 140.

Referring briefly to FIG. 3B, operation of the primary display device 116, the secondary display device 118 and the player tracking display 140 may be controlled by a video controller 30 that receives video data from a processing circuit 12 or directly from a memory device 14 and displays the video data on the display screen. The credit display 120 and the bet display 122 are typically implemented as simple LCD or LED displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 3A, the display devices 116, 118, 140 may include, without limitation: a cathode ray tube, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touch-screen with an associated touch-screen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the EGM 100 are generally configured to display one or more game and/or non-game images, symbols, and indicia. In certain embodiments, the display devices 116, 118, 140 of the EGM 100 are configured to display any suitable visual representation or exhibition of the movement of objects; dynamic lighting; video images; images of people, characters, places, things, and faces of cards; and the like. In certain embodiments, the display devices 116, 118, 140 of the EGM 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The EGM 100 also includes various features that enable a player to deposit credits in the EGM 100 and withdraw credits from the EGM 100, such as in the form of a payout of winnings, credits, etc. For example, the EGM 100 may include a ticket dispenser 136, a bill/ticket acceptor 128, and a coin acceptor 126 that allows the player to deposit coins into the EGM 100.

As illustrated in FIG. 3A, the EGM 100 may also include a currency dispenser 137 that may include a note dispenser configured to dispense paper currency and/or a coin generator configured to dispense coins or tokens in a coin payout tray.

The EGM 100 may further include one or more speakers 150 controlled by one or more sound cards 28 (FIG. 3B). The EGM 100 illustrated in FIG. 3A includes a pair of speakers 150. In other embodiments, additional speakers, such as surround sound speakers, may be provided within or on the cabinet 105. Moreover, the EGM 100 may include built-in seating with integrated headrest speakers.

In various embodiments, the EGM 100 may generate dynamic sounds coupled with attractive multimedia images displayed on one or more of the display devices 116, 118, 140 to provide an audio-visual representation or to otherwise display full-motion video with sound to attract players to the EGM 100 and/or to engage the player during gameplay. In certain embodiments, the EGM 100 may display a sequence of audio and/or visual attraction messages during idle periods to attract potential players to the EGM 100. The videos may be customized to provide any appropriate information.

The EGM 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the EGM 100 may include an electronic payout device or module configured to fund an electronically recordable identification card or smart card or a bank or other account via an electronic funds transfer to or from the EGM 100.

FIG. 3B is a block diagram that illustrates logical and functional relationships between various components of an EGM 100. As shown in FIG. 3B, the EGM 100 may include a processing circuit 12 that controls operations of the EGM 100. Although illustrated as a single processing circuit, multiple special purpose and/or general-purpose processors and/or processor cores may be provided in the EGM 100. For example, the EGM 100 may include one or more of a video processor, a signal processor, a sound processor and/or a communication controller that performs one or more control functions within the EGM 100. The processing circuit 12 may be variously referred to as a “controller,” “microcontroller,” “microprocessor” or simply a “computer.” The processor may further include one or more application-specific integrated circuits (ASICs).

Various components of the EGM 100 are illustrated in FIG. 3B as being connected to the processing circuit 12. It will be appreciated that the components may be connected to the processing circuit 12 through a system bus, a communication bus and controller, such as a USB controller and USB bus, a network interface, or any other suitable type of connection.

The EGM 100 further includes a memory device 14 that stores one or more functional modules 20. Various functional modules 20 of the EGM 100 will be described in more detail below in connection with FIG. 3D.

The memory device 14 may store program code and instructions, executable by the processing circuit 12, to control the EGM 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The EGM 100 may further include a data storage device 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The EGM 100 may include a communication adapter 26 that enables the EGM 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or near field communications (NFC) that enable the EGM 100 to communicate, for example, with a mobile communication device operated by a player.

The EGM 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb drives, ticket readers, touch screens, trackballs, touchpads, wheels, and wireless communication devices. In some embodiments, internal or external peripheral devices may communicate with the processing circuit through a universal serial bus (USB) hub (not shown) connected to the processing circuit 12.

In some embodiments, the EGM 100 may include a sensor, such as a camera in communication with the processing circuit 12 (and possibly controlled by the processing circuit 12) that is selectively positioned to acquire an image of a player actively using the EGM 100 and/or the surrounding area of the EGM 100. In one embodiment, the camera may be configured to selectively acquire still or moving (e.g., video) images and may be configured to acquire the images in either an analog, digital or other suitable format. The display devices 116, 118, 140 may be configured to display the image acquired by the camera as well as display the visible manifestation of the game in split screen or picture-in-picture fashion. For example, the camera may acquire an image of the player and the processing circuit 12 may incorporate that image into the primary and/or secondary game as a game image, symbol or indicia.

The VR interface 192 may interact with a VR device 200. For example, in some embodiments, the VR interface 192 may provide a signal or trigger to cause the VR device 200 to toggle from off to a VR mode. In some embodiments, the VR interface 192 may be operable to receive an input that causes the mode to toggle.

Various functional modules of that may be stored in a memory device 14 of an EGM 100 are illustrated in FIG. 3C. Referring to FIG. 3C, the EGM 100 may include in the memory device 14 a game module 20A that includes program instructions and/or data for operating a hybrid wagering game as described herein. The EGM 100 may further include a player tracking module 20B, an electronic funds transfer module 20C, a VR interface module 20D, an audit/reporting module 20E, a communication module 20F, an operating system 20G and a random number generator 20H. The player tracking module 20B keeps track of the play of a player. The electronic funds transfer module 20C communicates with a back-end server or financial institution to transfer funds to and from an account associated with the player. The VR interface module 20D interacts with a VR device 200 as described in more detail herein. The communication module 20F enables the EGM 100 to communicate with remote servers and other EGMs using various secure communication interfaces. The operating system kernel 20G controls the overall operation of the EGM 100, including the loading and operation of other modules. The random number generator 20H generates random or pseudorandom numbers for use in the operation of the hybrid games described herein.

In some embodiments, an EGM 100 comprises a personal device, such as a desktop computer, a laptop computer, a mobile device, a tablet computer or computing device, a personal digital assistant (PDA), or other portable computing devices. In some embodiments, the EGM 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 3D, an EGM 100′ may be implemented as a handheld device including a compact housing 105 on which is mounted a touchscreen display device 116 including a digitizer 152. An input button 130 may be provided on the housing and may act as a power or control button. A camera 127 may be provided in a front face of the housing 105. The housing 105 may include one or more speakers 150. In the EGM 100′, various input buttons described above, such as the cashout button, gameplay activation button, etc., may be implemented as soft buttons on the touchscreen display device 116. Moreover, the EGM 100′ may omit certain features, such as a bill acceptor, a ticket generator, a coin acceptor or dispenser, a card reader, secondary displays, a bet display, a credit display, etc. Credits can be deposited in or transferred from the EGM 100′ electronically.

FIG. 3E illustrates a standalone EGM 100″ having a different form factor from the EGM 100 illustrated in FIG. 3A. In particular, the EGM 100″ is characterized by having a large, high aspect ratio, curved primary display device 116′ provided in the housing 105, with no secondary display device. The primary display device 116′ may include a digitizer 152 to allow touchscreen interaction with the primary display device 116′. The EGM 100″ may further include a player tracking display 140, a plurality of input buttons 130, a bill/ticket acceptor 128, a card reader 138, and a ticket generator 136. The EGM 100″ may further include one or more cameras 127 to enable facial recognition and/or motion tracking.

Although illustrated as EGMs, similar functions and/or operations as described herein may include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, EGMs according to embodiments herein may be implemented using mobile terminals, such as smart phones, tablets, and/or laptop computers, among others.

### VR Controller

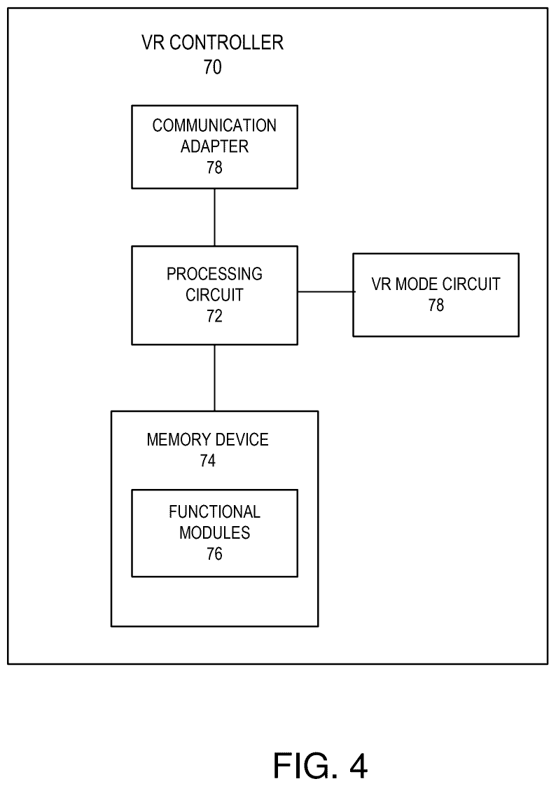

Reference is now made to FIG. 4, which is a block diagram that illustrates various components of a VR controller 70 according to some embodiments. As shown in FIG. 4, the VR controller 70 may include a processing circuit 72 that controls operations of the VR controller 70. Although illustrated as a single processing circuit 72, multiple special purpose and/or general-purpose processors and/or processor cores may be provided in the VR controller 70. For example, the VR controller 70 may include one or more of a video processor, a signal processor, a sound processor and/or a communication controller that performs one or more control functions within the VR controller 70. The processing circuit 72 may be variously referred to as a “controller,” “microcontroller,” “microprocessor” or simply a “computer.” The processing circuit may further include one or more application-specific integrated circuits (ASICs).

Various components of the VR controller 70 are illustrated in FIG. 4 as being connected to the processing circuit 72. It will be appreciated that the components may be connected to the processing circuit 72 through a system bus, a communication bus and controller, such as a USB controller and USB bus, a network interface, or any other suitable type of connection.

The VR controller 70 further includes a memory device 74 that stores one or more functional modules 76 for performing the operations described above.

The memory device 74 may store program code and instructions, executable by the processing circuit 72, to control the VR controller 70. The memory device 74 may include random access memory (RAM), which can include non-volatile RAM (NVRAM), magnetic RAM (MRAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The VR controller 70 may include a communication adapter 78 that enables the VR controller 70 to communicate with remote devices, such as EGMs 100, coin pusher games 90 and/or a player tracking server 45 (FIG. 1) over a wired and/or wireless communication network, such as a local area network (LAN), wide area network (WAN), cellular communication network, or other data communication network.

The VR controller 70 may include a VR mode circuit 78 that may cause the VR device to change modes from off to on.

The VR controller 70 may include one or more internal or external communication ports that enable the processing circuit 72 to communicate with and to operate with internal or external peripheral devices, such as display screens, keypads, mass storage devices, microphones, speakers, and wireless communication devices. In some embodiments, internal or external peripheral devices may communicate with the processing circuit 72 through a universal serial bus (USB) hub (not shown) connected to the processing circuit 72.

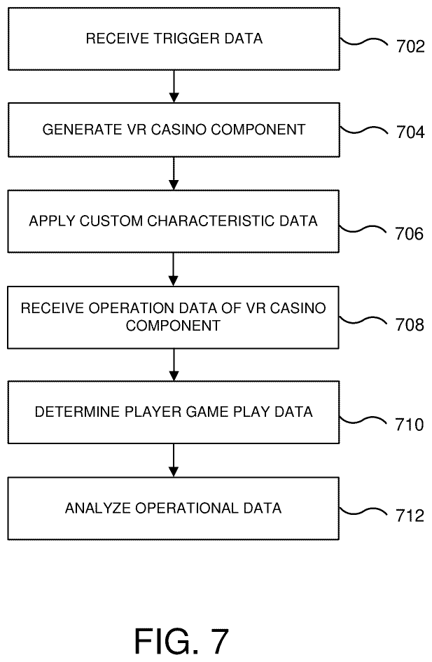

Reference is now made to FIG. 7, which is a flowchart illustrating operations of systems/methods for generating VR casinos according to some embodiments. Operations according to some embodiments include receiving (block 702), into a processing circuit, trigger data that corresponds to a virtual reality (VR) casino component. Some embodiments provide that trigger data may include one or more of a player event, a casino event, a time, a customer trigger a regulatory event and/or an operational data trigger.

In some embodiments, the trigger data includes custom trigger data that corresponds to a regulatory requirement and the operations further include regenerating the VR casino component to comply with the regulatory requirement.

Operations may provide that the VR casino component includes a VR casino model that includes virtual electronic game machines (EGMs), virtual electronic table games (ETGs), and/or virtual casino furnishings, among others.

Operations may include generating (block 704), by the processing circuit, a VR casino component that corresponds to the trigger data. Some embodiments provide that a VR casino component may include one or more of an entire VR casino or a portion of a VR casino, such as a specific room in a VR casino. In some embodiments the VR casino component may be a single machine and/or block of machines in a VR casino. In some embodiments, the VR casino component may be a gaming table, a structural feature and/or other feature in the VR casino.

In some embodiments, the VR casino component includes a VR single room of a VR casino that includes a plurality of VR casino rooms. In some embodiments, the VR casino component includes a VR model of a physical casino. In such embodiments, the VR casino component may be based on VR physical data generated using casino cameras in the physical casino. Some embodiments provide that the VR casino component includes a casino with selected ones of multiple EGMs that are in the physical casino.

Operations may include applying (block 706) custom characteristic data that is associated with an operator of the VR casino component to generate a VR casino component model.

Operations may include receiving (block 708) operational data that is associated with performance of the VR casino component.

In some embodiments, the VR casino component includes a first VR casino that is playable by a first player. In response to receiving trigger data corresponding to a second player, the VR casino component may include a second VR casino that is different from the first VR casino and that is played by the second player at a same time as the first player is playing the first VR casino.

In some embodiments, the trigger data includes player event data corresponding to an activity performed by a player in the VR casino component. Some embodiments provide that the trigger data includes a casino event that corresponds to a casino condition occurring in the VR casino component. Some embodiments include a casino event database that stores event data corresponding to multiple casino events. Casino events may include a given time of day, a given promotion beginning or end, a lucky element event, and/or detection of underperformance and/or over performance of part or all of the VR casino.

In some embodiments, operations include determining (block 710) player game play data based on a player game play analysis. In such embodiments, generating the VR casino component may be based on the player game play data.

Some embodiments include generating the VR casino component by generating three-dimensional models, graphics and/or sounds corresponding to VR casino component.

In some embodiments, the VR casino component may include a first 3D VR casino component that includes a first rule set for accessing the first VR casino component and a second VR casino component including a second rule set for accessing the second VR casino component. In such embodiments the second rule set may be different from the first rule set.

In some embodiments, a player begins playing the first VR casino component and the processor circuit is caused to send an offer to the player to play in a second VR casino component. In such embodiments, responsive to the offer to play in the second VR casino component, the player is transitioned to the second VR casino component.

In some embodiments, the VR casino component includes a celebrity theme corresponding to a celebrity and a celebrity avatar corresponding to the celebrity. In some embodiments, a player avatar corresponding to a non-celebrity in the 3D VR casino component may be invisible to the celebrity playing in the VR casino component.

Operations may include analyzing (block 712) operational data of the VR casino component to determine performance of an element in the VR casino component. For example, in response to the performance of the element being either above an upper performance threshold or below a lower performance threshold, operations may include regenerating the element in the VR casino component. In some embodiments, regenerating includes using artificial intelligence to generate a model of the VR casino component.

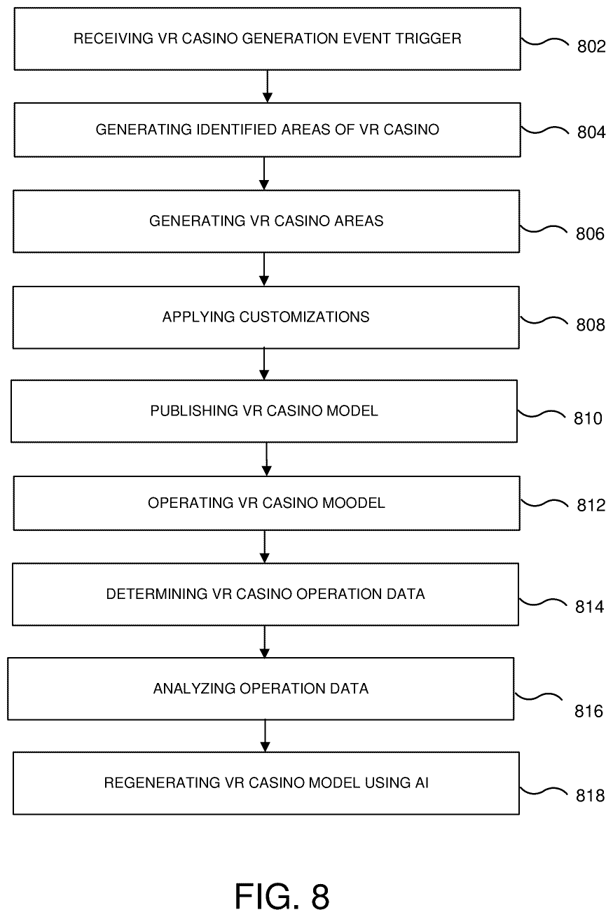

Reference is now made to FIG. 8, which is a flowchart illustrating operations of systems/methods for generating VR casinos according to some embodiments. Operations include receiving (block 802), into a VR casino generation server, a VR casino generation event trigger that is based on VR casino related events and generating (block 804) identified areas of the VR casino based on the VR casino relate events. Embodiments include generating (block 806) VR casino areas that are identified and applying (block 808) customizations that correspond to a customer to the VR casino areas to provide a VR casino model. Embodiments include publishing (block 810) the VR casino model in response to a publication event, operating (block 812), by a player, VR casino model, and determining (block 814) operation data corresponding to the VR casino model. Embodiments may include analyzing (block 816) the operation data to identify under performing areas and over performing areas and regenerating (block 818) the VR casino model using artificial intelligence based on the under performing areas and over performing areas.

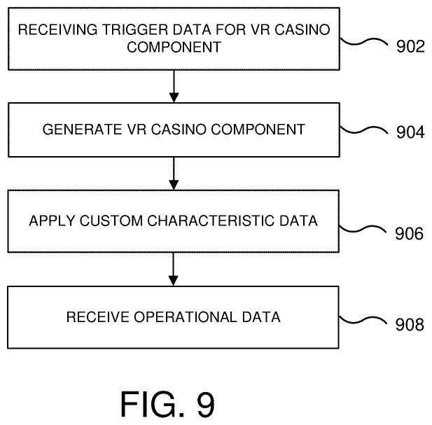

Reference is now made to FIG. 9, which is a flowchart illustrating operations of systems/methods for generating VR casinos according to some embodiments. Operations may include receiving (block 902), into a processing circuit, trigger data that corresponds to a virtual reality (VR) casino component. In some embodiments, the trigger data occurs based on a periodic time interval. Operations include generating (block 904), by the processing circuit, the VR casino component that corresponds to the trigger data and applying (block 906) custom characteristic data that is associated with an operator of the VR casino. The VR casino component may be associated with the operator to generate a VR casino component model. Some embodiments include receiving (block 908) operational data that is associated with performance of the VR casino component. In some embodiments, the processing circuit is further caused to analyze operational data of the VR casino component to determine performance of an element in the VR casino component. In some embodiments, in response to the performance of the element not being a range between a lower performance threshold and an upper performance threshold that is greater than the lower performance threshold, the processing circuit is caused to regenerate the element in the VR casino component. Some embodiments provide that regenerating includes using artificial intelligence to generate a model of the VR casino component.

### Other EGM Features

Embodiments described herein may be implemented in various configurations for EGMs 100s, including but not limited to: (1) a dedicated EGM, wherein the computerized instructions for controlling any games (which are provided by the EGM) are provided with the EGM prior to delivery to a gaming establishment; and (2) a changeable EGM, where the computerized instructions for controlling any games (which are provided by the EGM) are downloadable to the EGM through a data network when the EGM is in a gaming establishment. In some embodiments, the computerized instructions for controlling any games are executed by at least one central server, central controller or remote host. In such a “thin client” embodiment, the central server remotely controls any games (or other suitable interfaces) and the EGM is utilized to display such games (or suitable interfaces) and receive one or more inputs or commands from a player. In another embodiment, the computerized instructions for controlling any games are communicated from the central server, central controller or remote host to a EGM local processor and memory devices. In such a “thick client” embodiment, the EGM local processor executes the communicated computerized instructions to control any games (or other suitable interfaces) provided to a player.

In some embodiments, an EGM may be operated by a mobile device, such as a mobile telephone, tablet other mobile computing device. For example, a mobile device may be communicatively coupled to an EGM and may include a user interface that receives user inputs that are received to control the EGM. The user inputs may be received by the EGM via the mobile device.

In some embodiments, one or more EGMs in a gaming system may be thin client EGMs and one or more EGMs in the gaming system may be thick client EGMs. In another embodiment, certain functions of the EGM are implemented in a thin client environment and certain other functions of the EGM are implemented in a thick client environment. In one such embodiment, computerized instructions for controlling any primary games are communicated from the central server to the EGM in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more EGMs; and/or (c) one or more personal EGMs, such as desktop computers, laptop computers, tablet computers or computing devices, personal digital assistants (PDAs), mobile telephones such as smart phones, and other mobile computing devices.

In certain such embodiments, computerized instructions for controlling any games (such as any primary or base games and/or any secondary or bonus games) displayed by the EGM are executed by the central server, central controller, or remote host. In such “thin client” embodiments, the central server, central controller, or remote host remotely controls any games (or other suitable interfaces) displayed by the EGM, and the EGM is utilized to display such games (or suitable interfaces) and to receive one or more inputs or commands. In other such embodiments, computerized instructions for controlling any games displayed by the EGM are communicated from the central server, central controller, or remote host to the EGM and are stored in at least one memory device of the EGM. In such “thick client” embodiments, the at least one processor of the EGM executes the computerized instructions to control any games (or other suitable interfaces) displayed by the EGM.

In some embodiments in which the gaming system includes: (a) an EGM configured to communicate with a central server, central controller, or remote host through a data network; and/or (b) a plurality of EGMs configured to communicate with one another through a data network, the data network is an internet or an intranet. In certain such embodiments, an internet browser of the EGM is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the EGM, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the EGM.

It should be appreciated that the central server, central controller, or remote host and the EGM are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of EGMs to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

Embodiments provided herein may provide improved accessibility to wagering stations by including additional user interface technologies, such as virtual and/or augmented reality. Such embodiments may improve technological efficiency by coordinating the augmented reality with examples of different types of wagering stations.

### Further Definitions and Embodiments

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product comprising one or more computer readable media having computer readable program code embodied thereon.

Any combination of one or more computer readable media may be used. The computer readable media may be a computer readable signal medium or a non-transitory computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a non-transitory computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

1. A system comprising:
a communication interface;
a processing circuit; and
a memory coupled to the processing circuit, the memory comprising machine readable instructions that, when executed by the processing circuit, cause the processing circuit to:
receive, into the processing circuit, trigger data that corresponds to a virtual reality (VR) casino component;
generate, by the processing circuit, the VR casino component that corresponds to the trigger data;
apply custom characteristic data that is associated with an operator of the VR casino component to generate a VR casino component model; and
receive operational data that is associated with performance of the VR casino component.

2. The system of claim 1, wherein the VR casino component comprises a first VR casino that is playable by a first player,
wherein, responsive to receiving trigger data corresponding to a second player, the VR casino component further comprises a second VR casino that is different from the first VR casino and that is played by the second player at a same time as the first player is playing the first VR casino.

3. The system of claim 1, wherein the trigger data comprises player event data corresponding to an activity performed by a player in the VR casino component.

4. The system of claim 1, wherein the trigger data comprises a casino event that corresponds to a casino condition occurring in the VR casino component.

5. The system of claim 4, wherein the system further comprises a casino event database that stores event data corresponding to a plurality of casino events.

6. The system of claim 1, wherein the trigger data comprises custom trigger data that corresponds to a regulatory requirement, and
wherein the processing circuit is further caused to regenerate the VR casino component to comply with the regulatory requirement.

7. The system of claim 1, wherein the VR casino component comprises a VR casino model that comprises virtual electronic game machines (EGMs), virtual electronic table games (ETGs), and virtual casino furnishings.

8. The system of claim 1, wherein the VR casino component comprises a VR single room of a VR casino that comprises a plurality of VR casino rooms.

9. The system of claim 1, wherein the VR casino component comprises a VR model of a physical casino.

10. The system of claim 9, wherein the VR casino component is based on VR physical data generated using casino cameras in the physical casino.

11. The system of claim 9, wherein the VR casino component comprises a casino with selected ones of a plurality of EGMs that are in the physical casino.

12. The system of claim 1, wherein the processing circuit is further caused to determine player game play data based on a player game play analysis, and
wherein generating the VR casino component is based on the player game play data.

13. The system of claim 1, wherein generating the VR casino component comprises generating three-dimensional models, graphics and sounds corresponding to VR casino component.

14. The system of claim 1, wherein the VR casino component comprises a first 3D VR casino component comprising a first rule set for accessing the first VR casino component and a second VR casino component comprising a second rule set for accessing the second VR casino component, and wherein the second rule set is different from the first rule set.

15. The system of claim 14, wherein a player begins playing the first VR casino component, wherein processor circuit is caused to send an offer to the player to play in a second VR casino component, and
wherein, responsive to the offer to play in the second VR casino component, a second player is transitioned to the second VR casino component.

16. The system of claim 1, wherein the VR casino component comprises a celebrity theme corresponding to a celebrity and a celebrity avatar corresponding to the celebrity, and
wherein a player avatar corresponding to a non-celebrity in the 3D VR casino component is invisible to the celebrity playing in the VR casino component.

17. The system of claim 1, wherein the processing circuit is further caused to analyze operational data of the VR casino component to determine performance of an element in the VR casino component.

18. The system of claim 17, wherein, responsive to the performance of the element being either above an upper performance threshold or below a lower performance threshold, the processing circuit is further caused to regenerate the element in the VR casino component, wherein regenerating comprises using artificial intelligence to generate a model of the VR casino component.

19. A method comprising:
receiving, into a VR casino generation server, a VR casino generation event trigger that is based on VR casino related events;
generating identified areas of the VR casino based on the VR casino relate events;
generating VR casino areas that are identified;
applying customizations that correspond to a customer to the VR casino areas to provide a VR casino model;
publishing the VR casino model in response to a publication event;
operating, by a player, the VR casino model;
determining operation data corresponding to the VR casino model;
analyzing the operation data to identify under performing areas and over performing areas; and
regenerating the VR casino model using artificial intelligence based on the under performing areas and over performing areas.

20. A device comprising:
a processing circuit; and
a memory coupled to the processing circuit, the memory comprising machine readable instructions that, when executed by the processing circuit, cause the processing circuit to:
receive, into the processing circuit, trigger data that corresponds to a virtual reality (VR) casino component, wherein the trigger data occurs based on a periodic time interval;
generate, by the processing circuit, the VR casino component that corresponds to the trigger data;
apply custom characteristic data that is associated with an operator of the VR casino component that is associated with an operator to generate a VR casino component model; and
receive operational data that is associated with performance of the VR casino component,
wherein the processing circuit is further caused to analyze operational data of the VR casino component to determine performance of an element in the VR casino component,
wherein, responsive to the performance of the element not being a range between a lower performance threshold and an upper performance threshold that is greater than the lower performance threshold, the processing circuit is further caused to regenerate the element in the VR casino component, and wherein regenerating comprises using artificial intelligence to generate a model of the VR casino component.
